(19) United States
(12) Patent Application Publication
(10) Pub. No.: US 2003/0061243 A1
(43) Pub. Date: Mar. 27, 2003

(54) Information auto classification method and information search and analysis method

(76) Inventors: Jeong Jung Kim, Suwon (KR); Bon-Gun Ku, Pyungtaek (KR)

Correspondence Address: BIRCH STEWART KOLASCH & BIRCH, PO BOX 747, FALLS CHURCH, VA, 22040-0747, US

(21) Appl. No.: 10/227,283

(22) Filed: Aug. 26, 2002

Related U.S. Application Data
(63) Continuation-in-part of application No. 09/316,039, filed on May 21, 1999, now abandoned.

(30) Foreign Application Priority Data
May 21, 1998 (KR) 18689/1998

(51) Int. Cl. G06F 12/00

(52) U.S. Cl. 707/200

(57) ABSTRACT

An information classification method includes many steps. In one step a search destination for information stored in an information source is selected, and a classification field with respect to the information is set. In another step the search destination information is searched and judged whether there is a classification field in the information. Another step automatically classifies the searched information based on the classification field. Another step stores the classified information into the database of the user. The present invention thereby automatically classifies the information stored in an information source, stores the classified information into the database of a user and effectively searches and analyzes information using a database system which stores the classified information and displays and outputs the information in various forms.

### BACKGROUND OF THE INVENTION

1. Field of the Invention

The present invention relates to an information auto classification method and an information search and analysis method, and in particular to an information auto classification method and an information search and analysis method which are capable of searching certain information by connecting a user's database system to an information source, automatically classifying and storing the searched information into the user's database system and searching and analyzing information in the user's database based on various parameters such as a search and analysis condition and a sample condition which are inputted by a user using the system.

2. Description of the Background Art

When building an information database, a user searches and analyzes information based on various information sources and processes the searched information to correspond with the user's database. The thusly processed information is stored into the user's database and is read from the user's database based on a computation in accordance with a search condition set by a user.

For example, when building a patent information database, a user accesses an information source such as an external information database using a computation communication, a CD-ROM, etc. to search certain information. Thereafter, the user accesses desired information and processes the information to correspond to the user's needs with the database of the user. The thusly processed information is outputted from the database of the user. When searching, classifying and outputting certain information based on the built database, an original information is displayed and outputted using a keyword or a proper search condition.

However, in the above-described conventional method, the user has to manually search, classify and analyze a large amount of information and input the thusly processed information into the database. When the user searches and outputs the information from the database, the output condition is limited. Therefore, in order to output the data in a certain format, additional editing and other processes are needed. In addition, when another search is needed, the results of the previous search may not be used. Therefore, the search should be performed from the first stage again. This consumes a lot of time.

### SUMMARY OF THE INVENTION

Accordingly, it is an object of the present invention to overcome the problems which occur during information classification and the information search and analysis based on the classified information.

It is another object of the present invention to provide an information classification method which is capable of automatically classifying the information stored in an information source and storing the classified information into the database of a user.

It is another object of the present invention to provide a method which is capable of effectively searching and analyzing information using a database system which stores the classified information and displaying and outputting the information in various forms.

To achieve the above objects, there is provided an information classification method according to the present invention which includes a step for selecting a search destination information stored in an information source and setting a classification field with respect to the information, a step for searching the search destination information and judging whether there is a classification field in the information, a step for automatically classifying the searched information based on the classification field, and a step for storing the classified information into the database of the user.

To achieve the above objects, there is provided an information search method according to the present invention which includes a step for setting a search condition for searching a certain information data from an information source, a step for displaying the value data on a screen with respect to the search result of the information data based on the set search condition, and a step for classifying the contents of each search result information data corresponding to the value data into the contents of a plurality of fields formed of a set character reference from the information contents of more than one field.

To achieve the above objects, there is provided an information analysis method according to the present invention which includes a step for setting a search condition for searching an information data from a storing medium, a step for displaying a value data on a screen with respect to a search result of the information data based on the inputted search condition, a step for displaying a statistic value on a screen in a graphic format with respect to the analysis result of the search information data in accordance with the set analysis condition, and a step for classifying the contents of an information data corresponding to the graphic displayed on the screen into the contents of a plurality of fields formed of a set character reference from the information contents of more than one field.

Additional advantages, objects and features of the invention will become more apparent from the description which follows.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating a method for searching, classifying and storing information according to the present invention;

FIG. 2 is a schematic view illustrating the construction of an entire network of an integrated database system according to the present invention;

FIG. 3 is a view illustrating the construction of a data among information data stored in a hard disk drive (HDD) for the system of FIG. 2;

FIG. 4 is a flow chart illustrating an information data search method for the system of FIG. 3;

FIGS. 5 and 6 are views illustrating initial windows on a screen which are provided when an integrated information management system is accessed via a web browser;

FIG. 7 is a view illustrating a patent search menu window of an integrated information management system for an information data search of a user according to the present invention;

FIG. 8 is a flow chart illustrating an embodiment of an analysis method of an information data according to the present invention;

FIGS. 9 and 10 are views illustrating tree map type windows resulting from an information data analysis;

FIG. 11 is a view illustrating a pipe chart window resulting from an information data analysis;

FIG. 12 is a view illustrating a trend map window resulting from an information data analysis;

FIG. 13 is a view illustrating a bar map window resulting from an information data analysis;

FIGS. 14A and 14B are views illustrating pipe map windows resulting from an information data analysis;

FIG. 15 is a view illustrating a window of detailed patent information data; and

FIG. 16 is a view illustrating a window of detailed patent drawing information data.

### DETAILED DESCRIPTION OF THE PREFERRED EMBODIMENTS

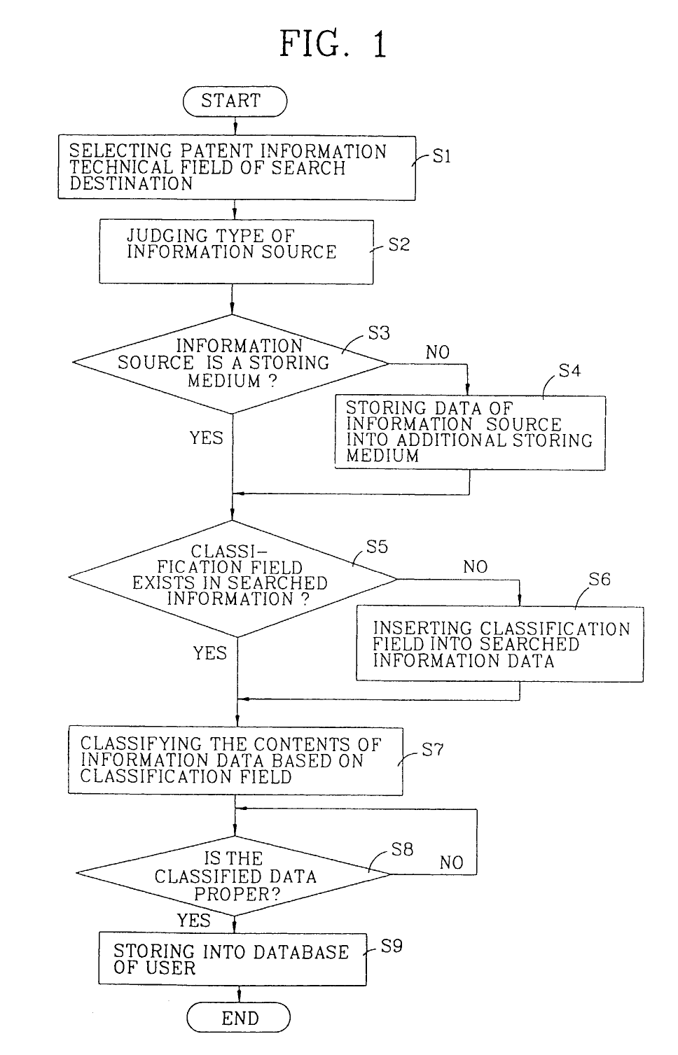

FIG. 1 is a flowchart illustrating an information classification method according to the present invention.

As shown therein, a user selects a certain patent technical field in Step SI. The user determines an information source type which is used for a search in Step S2. Namely, the user judges whether the information source is an external or internal patent information database, such as a CD ROM containing patent information, or an optical file via an internet or a PC communication. If the information source is an external database which is accessed only via a computer communication and is not a storing medium such as a CD ROM, an optical file or a magnetic tape, or which is an information source which is not compatible to the database of the user, the information stored in the information source is copied or downloaded and then is stored onto a storing medium connected with the database of the user in Step S4.

Next, it is judged whether the classification field which is classified by the user is in the information in Step S5. If the field is not therein, the user inputs the classification field into a corresponding position of the information to be compatible with the database in Step S6. Here, the classification field is referred to as a field for classifying the data in the information source by the user. For example, when the user wishes to classify the patent information by the field, the classification field is referred to as the object of the invention, an embodiment, an effect, claims, drawings, IPC (International Patent Classification) number, an application number, a publication number, a patent serial number, etc.

When the system is ready to classify the information by the field, the information is automatically classified into a certain classification field based on an information classification program which is programmed so that the information becomes compatible with the database of the user in Step S7. Thereafter, it is judged whether the data of the classified information is reliable in Step S8.

The thusly classified information is stored into the database in Step S9. The information classification program may be programmed by the user. For example, in the case that the information of the information source has image information and text information, it is programmed to classify and store the image information and the text information. In addition, if the information source includes only text information, the image information may be stored to be compatible with the database via the copy or download operation.

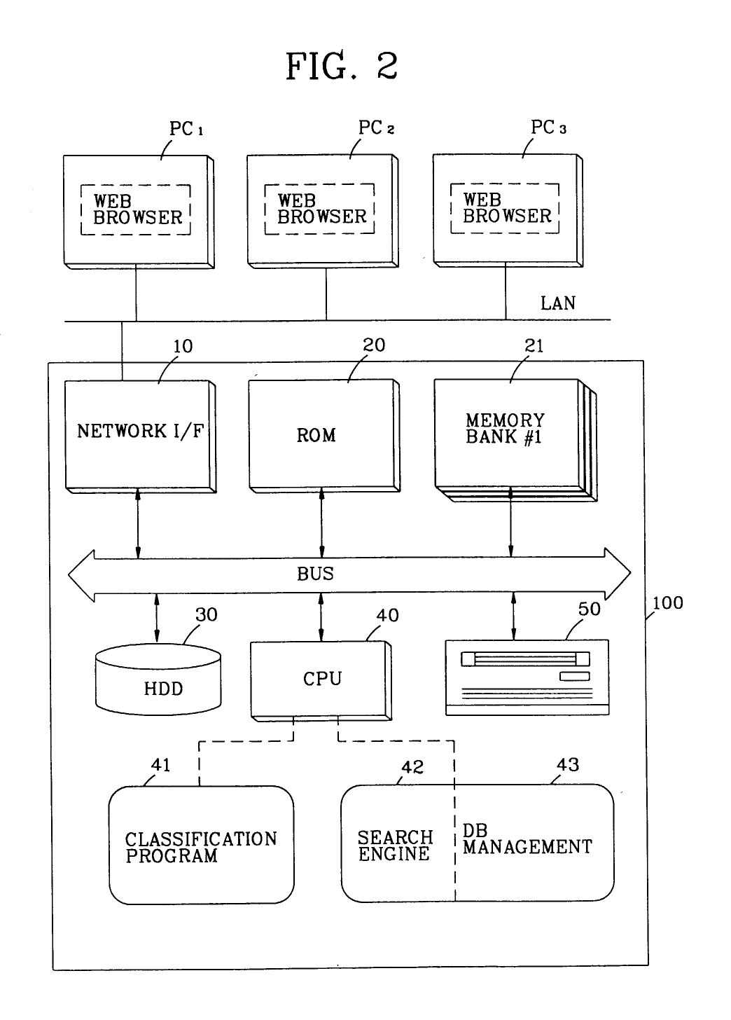

FIG. 2 illustrates the construction of a network for an integrated database system according to the present invention. As shown therein, the system includes a network interface 10 for exchanging data with a plurality of search terminals PC1, PC2, . . . , via a network. The system also includes, a ROM 20 for storing a system initialization program and O/S driving program, a memory bank 21 for loading a program, a central processing unit (CPU)40 for classifying, storing and searching the information data by performing the program loaded into the memory bank 21. A hard disk drive (HDD)30 includes the program for storing, classifying and searching the classified information data, and a CD ROM drive 50 is provided for receiving a CD ROM title containing patent information.

The process of searching and classifying information from the information source is shown in FIG. 1. During the process, information is searched and analyzed from the database via the integrated database system, according to the present invention, as will be explained with reference to FIG. 2.

The CD ROM, which is the information source, is inserted into the CD ROM drive 50, and the system loads certain information from the HDD 30 into the memory bank 21. The classification program 41 is ran by the CPU 40. The program 41 performs a classification operation with respect to the information sequentially read from the disk inserted into the CD ROM drive 50. Namely, the classification program 41 selects more than one classification field in accordance with the fact that there is a certain classification field in the information read from the disk. If there is a classification field, words and sentences having uniformity are detected based on the selected classification field for thereby implementing a classification operation.

In Japanese patent information data, in the abstract, the field of the object of the invention is in the form of a TO sentence. The field of the object of the invention is classified based on the TO sentence as well as the problems to be overcome. The BY sentence signals the description of the problem resolving member.

In the case of U. S. A. patent information data, the first sentence of the entire abstract is classified as the problem to be overcome, and the remaining sentences of the abstract are classified as the problem resolving member.

In the case of Korean patent information data having an abstract, the abstract portion is classified as the problems to be overcome. The claims are classified as the problem resolving member. In the case of Korean patent information data which does not have an abstract, the first sentence of the claims is classified as the problems to be overcome. The remaining sentences of the claims are classified as the problem resolving member for thereby implementing a basic data for the analyzing operation.

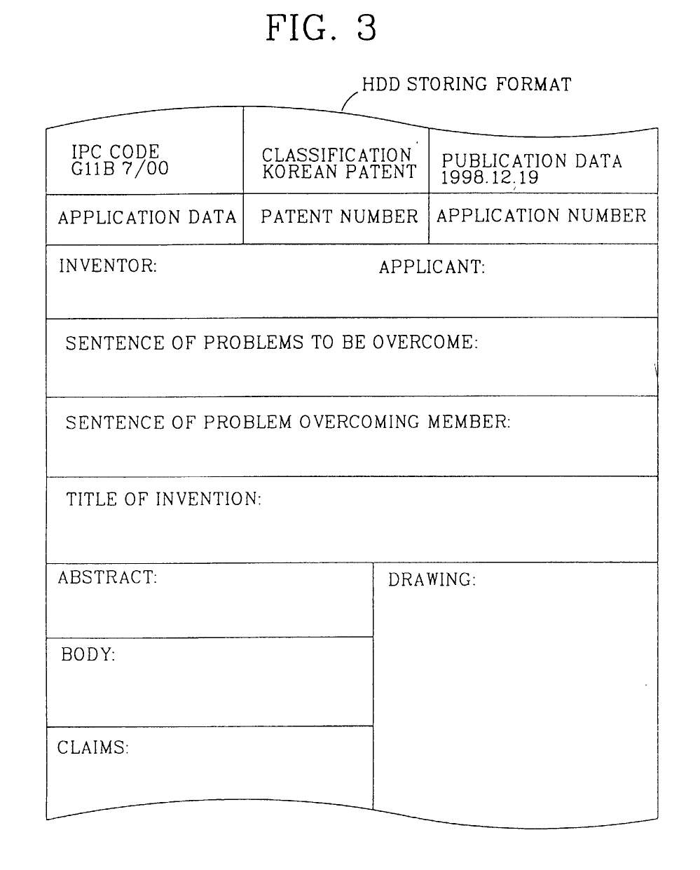

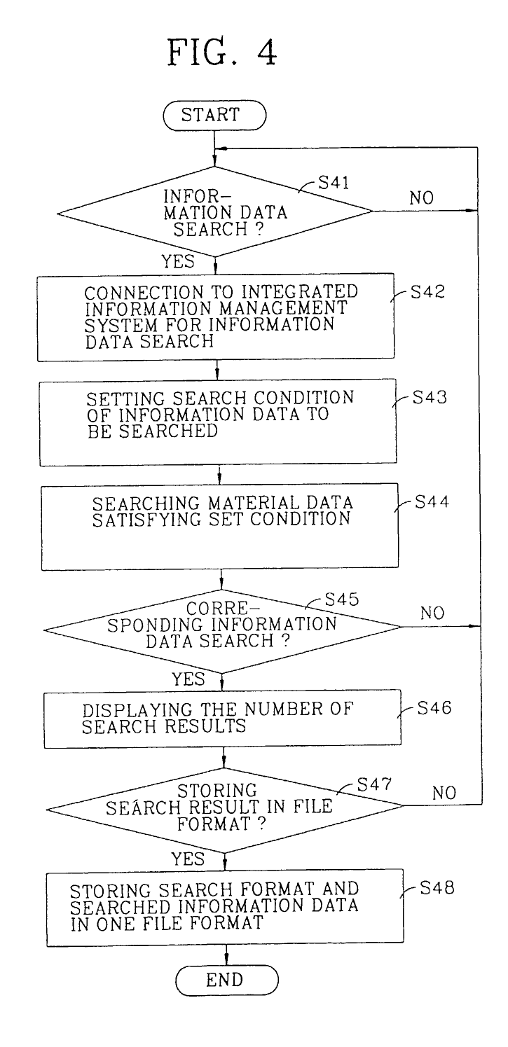

Therefore, the problems to be overcome and the items of the problem resolving member are extracted and classified. The patent information data which are reconstructed based on the thusly extracted and classified data, as shown in FIG. 3, are stored into the HDD 30. The classification program 41 performs the extraction and classification operations of a corresponding sentence based on all information data read from the CD ROM disk, so that all patent data stored in the disk are re-processed in the format as shown in FIG. 4 and stored into corresponding storing regions of the HDD 30. This arrangement creates a desired database for integrating with an information management system in accordance with the present invention.

FIG. 4 illustrates an embodiment of the search method for information data, according to the present invention. The search method according to the present invention will be explained with reference to FIG. 4.

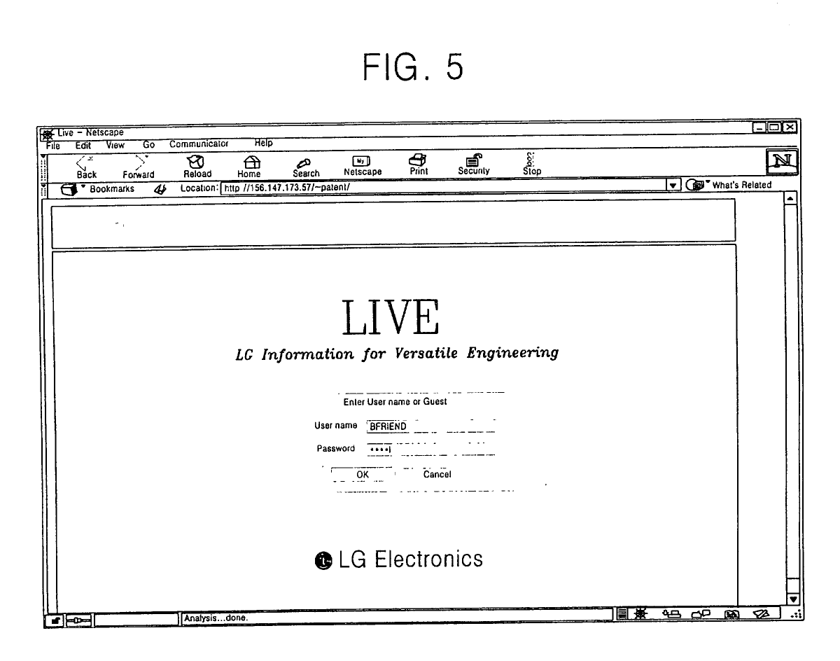

In the case of searching the patent data from the database of the integrated information management system, which is constructed to have the classification items based on the problems extracted by the keywords or sentence structure selected from the contents of more than one item, in Step S41, the user executes the web browser installed at the search terminal PC and accesses the search server 100 including the integrated information management database (DB) in Step S42. Next, the user receives the initial window as shown in FIG. 5. The server 100 loads the search engine and DB management program 43, which are programs for the data search and analysis via the search terminal, from the HDD 30 to the memory bank 21.

The search engine 42, which is the program installed at the search server 100, downloads a JAVA applet which is contained in the integrated information management system into a corresponding search terminal, via the network interface 10.

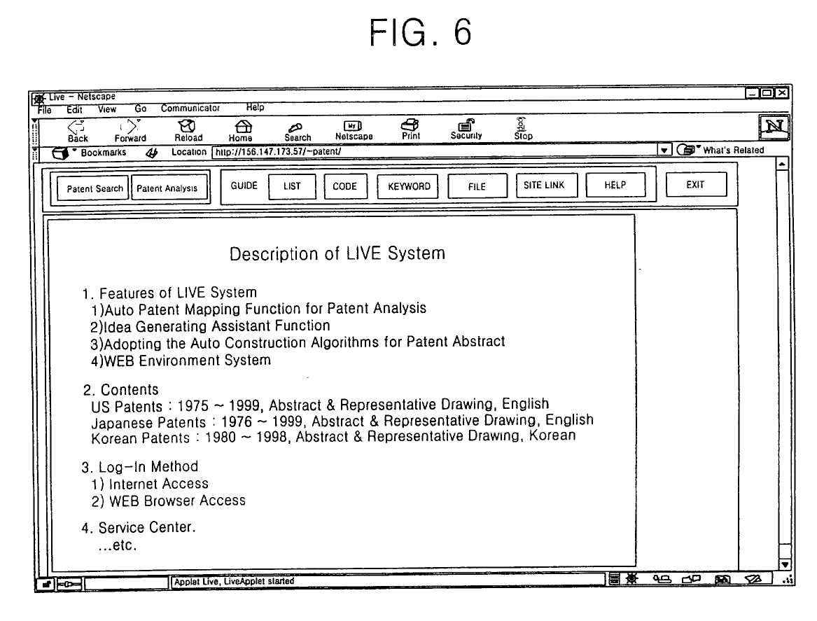

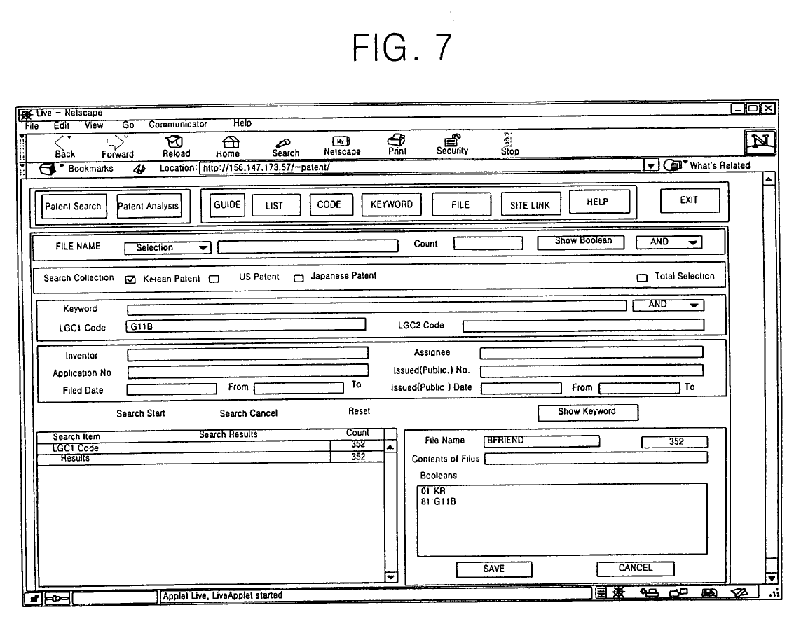

After a connection is made to the integration information management server 100, a search possible state is obtained. Input of a user name and password are requested in the initial window, as shown in FIG. 5. When the user name and password are inputted and are validated, an initial window provides a system specification, as shown in FIG. 6. The system specification is caused to be displayed on the screen by the integrated information management search server 100. After the user requests the patent search via the initial window of FIG. 6, the patent search menu, as shown in FIG. 7, appears. The patent search menu is also caused to be displayed by the integrated information management search server 100.

The user sets the search conditions of the data to be searched on the patent search menu of FIG. 7, in Step S43. Namely, a certain value among the input elements, such as the search destination of the patent information data, the technical classification field (IPC code and/or a user's set code), the search term(keyword), etc. is selected and entered. For example, the search destination: U. S. patent, technical classification code: G11B*, search term: Video.

The search engine 42 is loaded from the HDD 30 into the memory bank 21. The search engine 42 is ran by the CPU 40 and forms a query with respect to the condition values entered by the user. The search engine 42 transfers the query to the database management program 43 which is stored in the memory bank 21, so that the information data corresponding to the query is searched from the HDD 30 based on the database management program 43.

The database management program 43 searches the patent information data corresponding to the received query in Step S44. The input query is referred to as the search condition. The database management program 43 confirms whether the information data provided in the patent information data stored in the HDD 30 satisfies all of the set search conditions (as shown in FIG. 7).

For example, during a search, U. S. A. patent information data which includes patent data satisfying the search conditions set by the user, such as including the term of “video” and having a technology classification code of G11B* is searched and found in the HDD 30, in Step S45. The database management program 43 transfers the number of the searches, namely, the total number of the searched information data to a corresponding search terminal PC via the network interface 10. The patent information data corresponding to the conditions set by the user are displayed on the screen of the search terminal PC in Step S46.

After the data based on the patent search result are visually checked on the screen, the user stores the search result in a file format in Step S47. As shown in FIG. 7, on the patent search menu window, the contents of the search window displayed from the conditions selected by the user in the search mode, namely, the character stream such as (search destination=U.S. patent data) & (search word=video) & (search field)=G11B*) are moved to the search format window of the file storing window. After the user inputs the file name and the description of the information contents, and after the user selects the list storing option, the search engine 42, which receives the above-described selection contents, stores the index data. The index data is capable of indexing the search format based on the search result and the thusly obtained information data into the HDD 30, as a received file name, in Step S48. At this time, the region into which the data are stored become a specific directory to the user who logged in on the initial window of FIG. 5. When the same user logs in for a patent search, it is possible to obtain information based on only the file name with respect to the same search condition.

For example, when selecting the search result information stored in the file format, the search format of the selected file and the index data of the search information are loaded into the memory bank 21. In this state, when the user adds another search condition to the search conditions, for example, when a new search word of “Digital” is added, the search engine 42 forms a new search format of (search destination=U.S. patent data) & (search word=video&digital) & (search field=G11B*). The new search format includes the word “digital” and requests a new search to the database program 43, so that it is possible to more quickly obtain a search result and information data.

The thusly obtained search result information data is designated as a new file name and is stored into the HDD 30, so that the thusly stored data may be used for another search in the future.

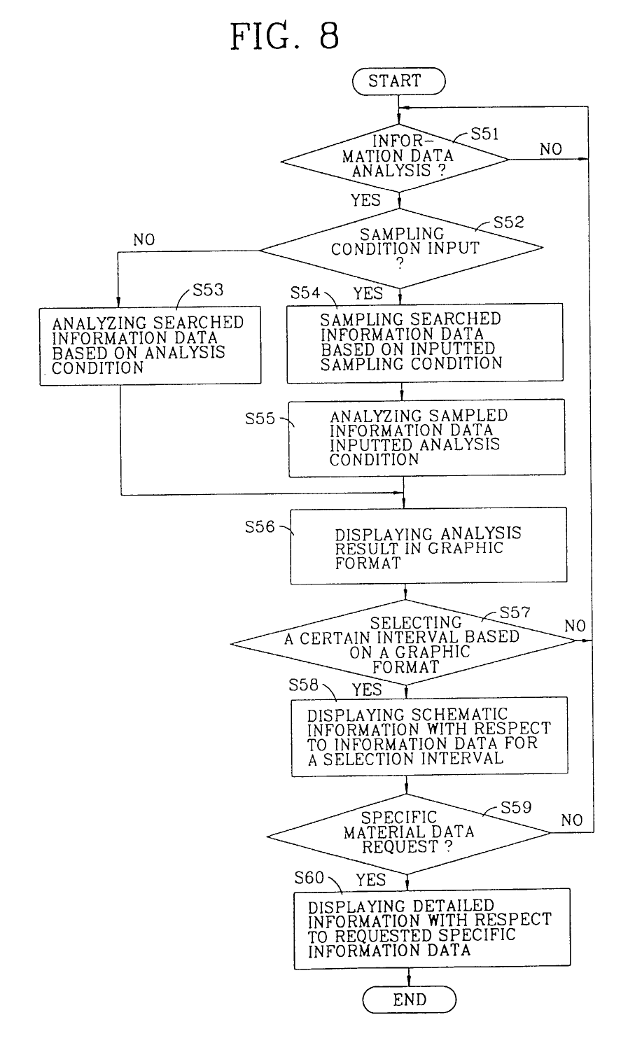

FIG. 8 illustrates a flow chart of an embodiment of the analyzing method of information data according to the present invention. The analyzing method is implemented using the data obtained in accordance with a search condition. The analyzing method of FIG. 8 will be explained with reference to the components of FIG. 2.

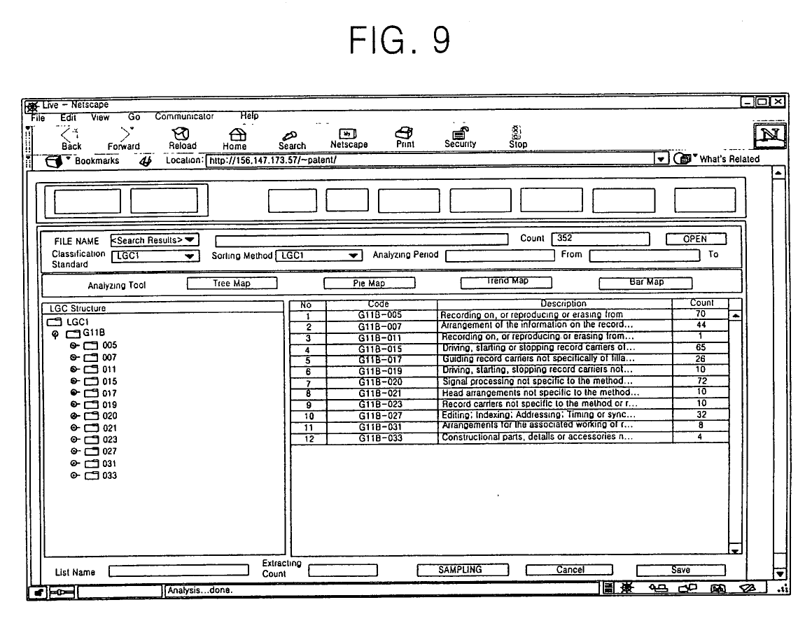

In order to check if there is a technology trend and certain data with respect to the searched patent information data, the user may select a patent analysis in Step S51. Next, a patent analysis menu window, in the form of a tree structure, is shown. The tree structure is formed of a corresponding technical field code having information as shown in FIG. 9, and is searched from the integrated information management search server 100.

On the patent analysis menu window, as shown in FIG. 9, the user sets the analyzing conditions of the information data. Namely, the user selectively inputs the technical classification code of the patent information data, the analysis period, etc. Assuming that the user inputs G11B as the technical classification code, and 96-97 as the analysis period, the analysis is performed with respect to the information data which satisfies the thusly inputted analysis conditions among the searched patent information data. Namely, the technical code of G11B as the technical classification code among the searched GI11A and G11B and the patent information data between the years of 96˜97, in Step S53.

The search engine 42, which is controlled by the CPU 40, selects only the information data which satisfies the analysis conditions set for the information data analysis among the searched patent information data. Then, the search engine 42 forms a tree structure of the international classification code (IPC code) of the selected information data. Next, the search engine 42 transfers the information data to a corresponding search terminal PC via the network interface 10. The information data is provided in a tree map form based on the international patent classification code with respect to the information data in Step S56 thereby implementing a certain data access.

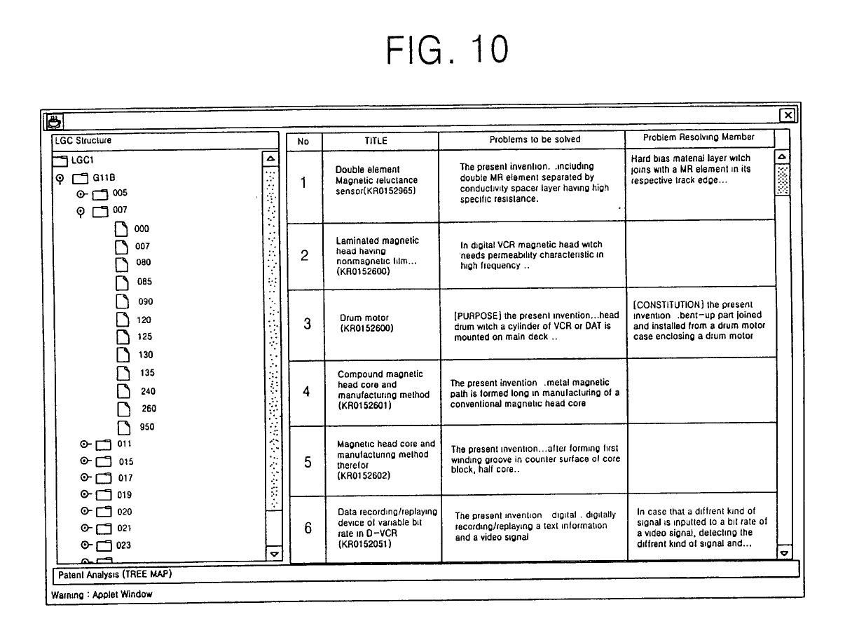

When the user selects G11B and 011 among the international patent classification (IPC) code displayed on the window in the tree map form, and selects 004 among its sub-codes of 002, 003, 004, the search engine 42 selects only the patent information data of the technical field of G11B011/004, having the selected 004 as a sub code. Next, the search engine 42 causes the problems to be overcome, the problem overcoming items, and the patent number contained in each patent information data to be sequentially displayed on the screen of the search terminal PC, as shown in FIG. 10. By this arrangement, it is possible to accurately confirm the problems to be overcome, and the contents of the problem overcoming items in the patent information data of a certain technical field.

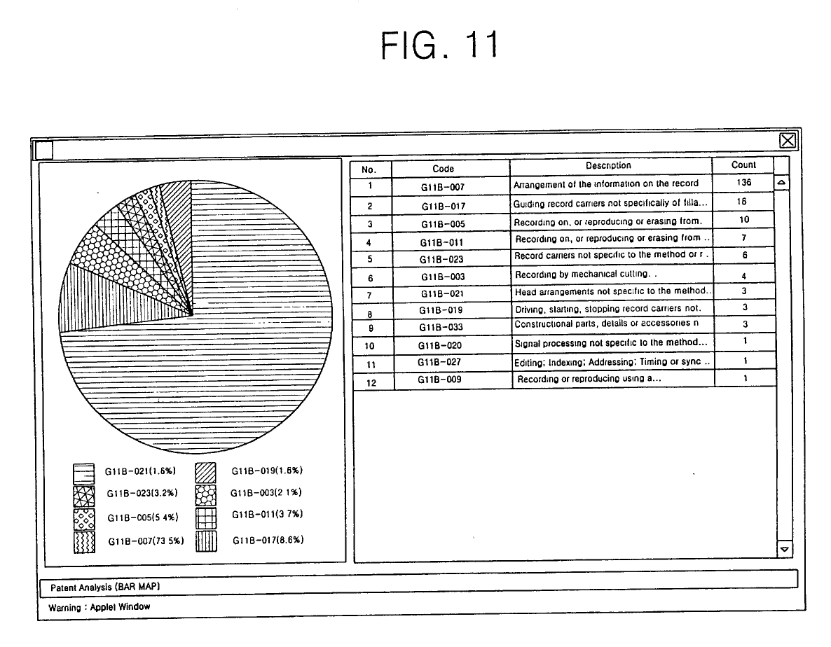

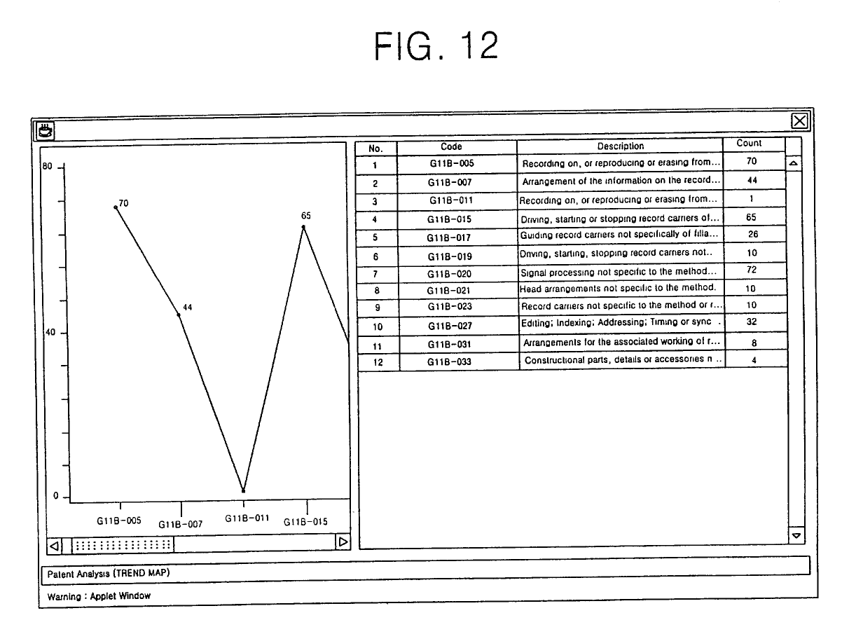

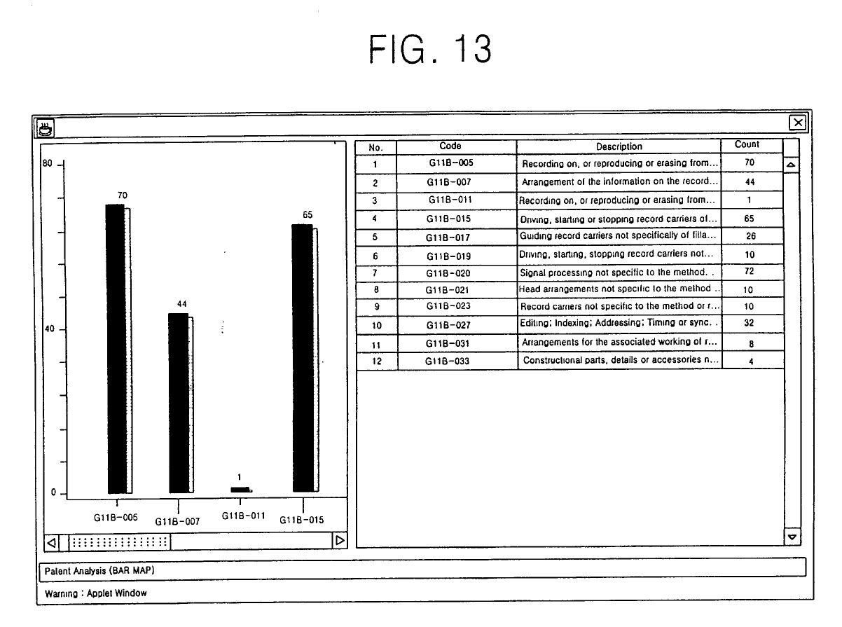

The analysis result may be formed in a tree map form or another graphic format. For example, the analysis result may be formed in a pie chart as shown in FIG. 11, a trend map form as shown in FIG. 12 or a bar map form as shown in FIG. 13. Namely, it is possible to implement various forms of graphic data.

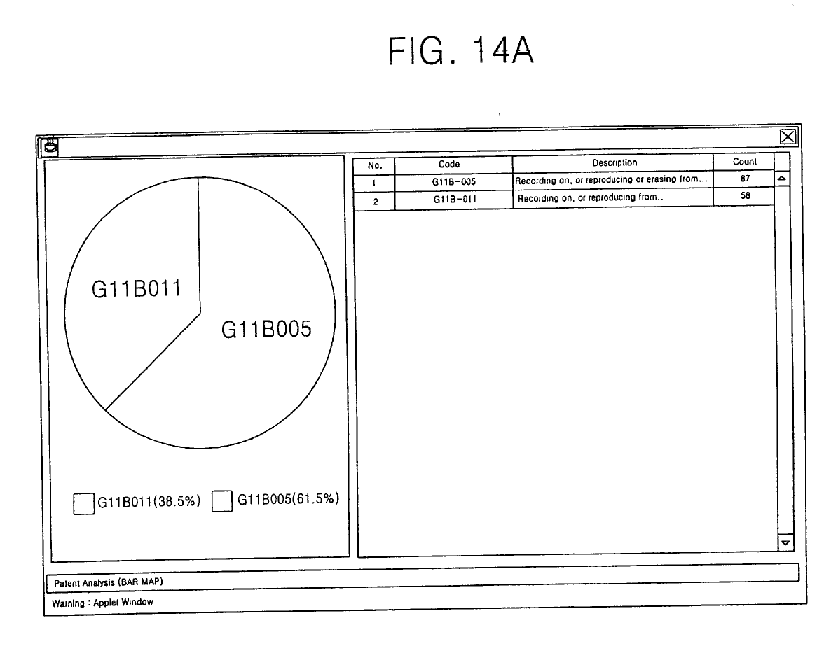

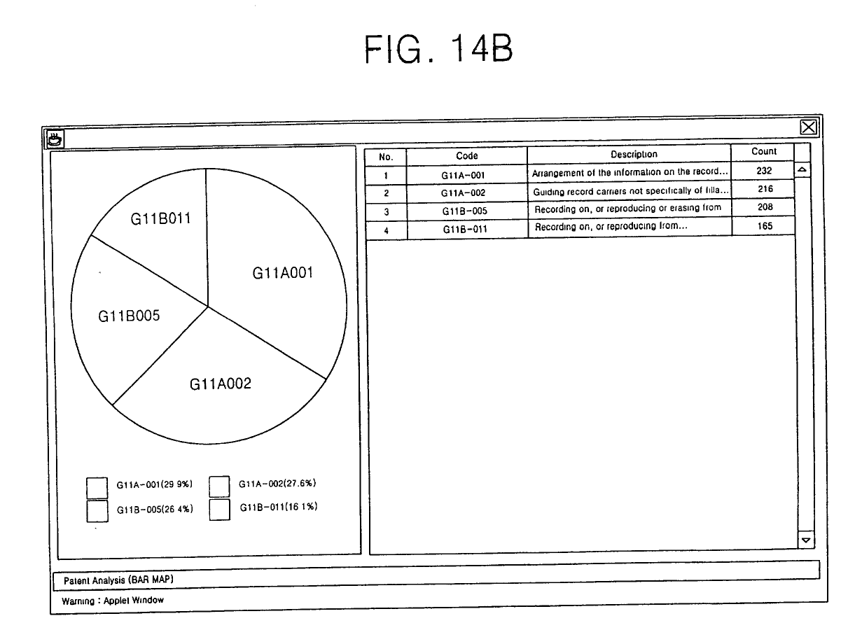

When forming the data in a graphic format based on the patent information data searched by the search engine 42, each region (for example, the eight sections in the pie chart of FIG. 11) of the graphic format may be formed based on the ratio obtained in accordance with a corresponding technical field code of the patent information data. This ratio may be expressed as one of the technical ratios of the lower stage of the upper technology, based on the upper technical code of the currently selected technical field code as 100% for the statistical value with respect to the analysis result information data. The number of the total resultant data is assumed as 100% irrespective of the stages on the tree structure of the currently selected technical field. By this manner, the ratio of a technical field corresponding to the same stages on the tree structure of the currently selected technical field is expressed. For example, the user selects 005 which is the sub code of G11B among the searched data in which the international patent classification code has the tree map form as shown in FIG. 9 and requests the analysis result in the pie chart form as shown in FIG. 11. At this time, the search engine 42 transfers the result of the analysis in a format as shown in FIG. 14A in which the search data having the technical classification code of G11B which is the upper code of 005 is 100% for thereby displaying the result on the screen. The data including the stage such as the lower code of 005 in all technical classification codes of the searched data, namely, the data having G11A XXX may be assumed as 100% for thereby transferring the data in the form as shown in FIG. 14B and displaying on the screen.

When the user selects a certain region (for example, FIG. 11) in the graphic format in Step S57, the CPU 40, which controls the search engine 42, selects only the patent information data contained in the region among the searched patent information data. Next, the CPU 40 extracts the information (application date, applicant, the title of the invention, etc.) of the selected information data. Next, the CPU 40 transfers the information to a corresponding search terminal PC via the network interface 10, in Step S58. By this arrangement, it is possible to easily confirm the information with respect to the information data contained in the selected interval or region based on the analysis result that the user provided in the graphic form.

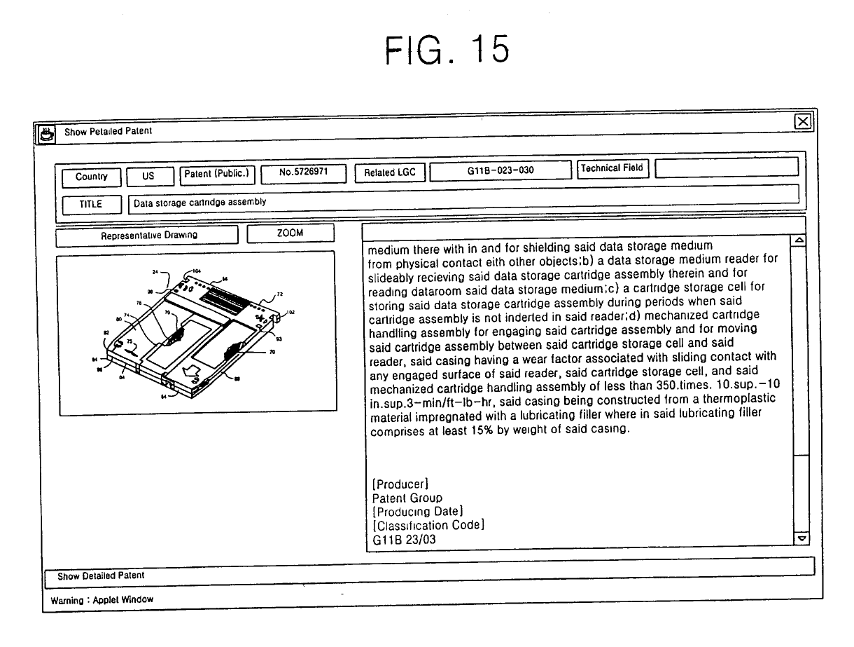

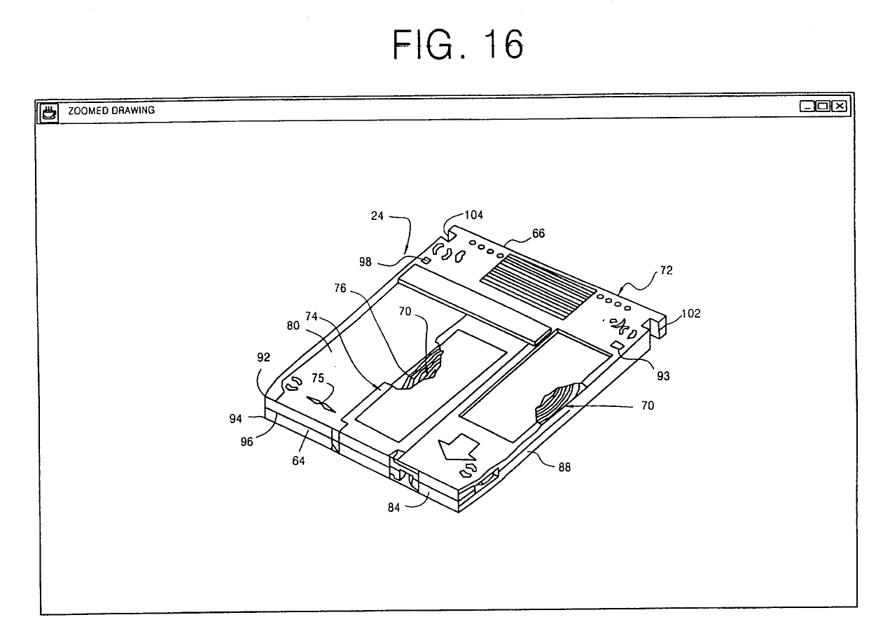

Specific data that the user wishes to know is confirmed based on the non-detailed information outputted on the screen and the problems to be overcome (problems and problems overcoming member) as shown in FIG. 10, and the service of the data is requested in Step S59. At this time, the CPU 40 extracts the requested information data among the searched information data and transfers the thusly extracted data to a corresponding search terminal PC via the network interface 10. The data as shown in FIG. 15 is displayed in Step S60. When the user requests an enlarged drawing, the CPU 40 provides the enlarged drawing data, as shown in FIG. 16, to the search terminal which requested the enlarged drawing.

In the embodiment of the present invention, the analysis process may be performed with respect to the searched information data or the information data selected for a specific field or year based on the analysis condition. In the case where there is a large volume of information data to be searched, the user may set a sampling condition (international patent classification code, year, etc.) on the patent analysis menu, as shown in FIG. 9. Afterwards, the user may request a sampling operation, in Step S52. At this time, the search engine 42 samples the searched patent information data based on the set sampling condition in Step S54. The analysis process is based on the sampled information data in Step S55. If the user inputs the year as the sampling condition and inputs 5% as the sampling ratio, when the user requests the sampling operation of the information data (assuming that there are 100 cases in 1981, 250 cases in 1982, . . . , 1221 cases in 1996, and 2% is the inputted sampling ratio), two cases are randomly selected in 1981, five cases are randomly selected in 1982, . . . , twenty-four cases are randomly selected in 1996. The analysis process is performed with respect to the selected patent information data. In addition, the sampling operation may be implemented based on a specific year, and the sampling operation may be designated based on the technical field. When the sampling operation is designated for each technical field, it is not needed to randomly select 5% for each year. Namely, the sampling data of the search data is selected from the search data of the year to obtain 5% for each technical field.

As described above, in the search and analysis method for information data according to the present invention, the data are classified into the problems to be overcome and the problem overcoming members for thereby providing information data. The thusly classified data are stored in the file format in connection with the search format of the data thereby implementing an easier access to the data. It is possible to implement a quick search of the information data without repeatedly performing the data search. Further, it is possible to sample the search result information data to thereby significantly decrease the amount of the analysis information data, so that it is possible to obtain a quick data analysis. In addition, the analysis result of the information data may be provided on the screen in various graphic formats such as the pie chart, tree map, trend map, bar chart, etc., so that it is possible to easily check the analysis result of the information data.

Although preferred embodiments of the present invention have been disclosed for illustrative purposes, those skilled in the art will appreciate that various modifications, additions and substitutions are possible, without departing from the scope and spirit of the invention as recited in the accompanying claims.

It is claimed:

1. A method for automatically processing patent materials, comprising the steps of:
accessing raw patent materials from an information source;
locating and reading text in individual patents of the raw patent materials, wherein the text concerns a technical field for the invention disclosed in the individual patent;
classifying the raw patent materials based on predetermined classifying conditions including the technical field for the invention and generating a classified patent-oriented database of the classified patent materials;
searching for specific patent materials among the classified patent materials in accordance with predetermined, user selected searching conditions and storing the searched patent materials meeting the searching conditions into a specific directory in the classified patent-oriented database;
analyzing the classified patent materials and/or the searched patent materials stored in the specific directory by predetermined, user selected analyzing conditions to generate analyzed patent materials; and
displaying the analyzed patent materials in a user selected information format.

2. The method according to claim 1, wherein said classifying conditions comprise specific words.

3. The method according to claim 1, wherein said analyzing conditions comprise specific classifying codes and/or key words.

4. The method according to claim 1, wherein said analyzing conditions comprise specific classifying codes and/or key words, and an analyzing term.

5. A method for classifying patent materials comprising the steps of:
accessing raw patent materials from an information source;
detecting text included in individual patents of the raw patent materials, wherein the text is located relative to pre-set specific words included in individual patents of the raw patent materials; and
classifying the raw patent materials on the basis of the detected text, wherein said text includes at least one of a title, a field of the invention, a problem to be solved by the invention, and a method or a means for a solution.

6. The method according to claim 5, wherein said classified patent materials comprise bibliographical information fields for the patent materials.

7. The method according to claim 6, wherein said bibliographical information fields include at least one of an inventor(s), applicant(s), application country, application date, application number, laid-open date, patent number and publication date.

8. The method according to claim 5, wherein said classifying step classifies the raw patent materials based upon text in the individual patents related to a cause and a result of the invention covered by the individual patents.

9. The method according to claim 5, wherein said classifying step classifies the raw patent materials based upon text in the individual patents related to an effect and a usage of the invention covered by the individual patents.

10. A method for generating a classified patent-oriented database, comprising the steps of:
accessing raw patent materials from an information source;
detecting pre-set specific words included in individual patents of the raw patent materials; and
storing classified patent materials, which are classified from the raw patent materials, based upon text in the individual patents associated with the pre-set specific words, wherein the text concerns at least one of a title, a field of the invention, a solution to problems, and a method or a means for a solution.

11. The method according to claim 10, wherein said classified patent materials comprise bibliographical information fields for the patent materials.

12. The method according to claim 11, wherein said bibliographical information fields include at least one of an inventor(s), applicant(s), application country, application date, application number, laid-open date, patent number and publication date.

13. The method according to claim 10, wherein said storing step stores the raw patent materials based upon text in the individual patents related to a cause and a result of the invention covered by the individual patents.

14. The method according to claim 10, wherein said storing step stores the raw patent materials based upon text in the individual patents related to an effect and a usage of the invention covered by the individual patents.

15. A method for searching patent materials, comprising the steps of:
accessing patent materials in a classified patent-oriented database, classified on the basis of pre-set specified words in the individual patents;
inputting user selected searching conditions, specific classification codes and/or specific key words;
searching the classified patent materials on the basis of the inputted searching conditions; and
generating a collection of the searched patent materials meeting the inputted searching conditions.

16. The method according to claim 15, wherein said accessing step further comprises a step for loading a file of the previously searched and stored patent materials.

17. The method according to claim 15, wherein said accessing step is capable of assessing the classified patent materials via an Internet web browser.

18. The method according to claim 15, wherein said specific classification codes comprise International Patent Classification codes.

19. The method according to claim 15, wherein said specific classification codes comprise user defined structure classification codes structurally classifying the classified patent materials and/or user defined function classification codes functionally classifying the classified patent materials.

20. The method according to claim 15, wherein said searching conditions further comprise at least one of inventor(s), applicant(s), application country, application date, application number, laid-open number, terms in the laid-open application, and patent numbers.

21. The method according to claim 15, wherein said searching step further comprises a step for storing the searched patent materials as a file.

22. The method according to claim 15, wherein said searched patent materials comprise the specific classification codes and the number of searched materials corresponding to the specific classification codes.

23. The method according to claim 15, wherein said searched patent materials are edited to be shifted or deleted.

24. The method according to claim 23, wherein said edited patent materials are stored as a file.

25. The method according to claim 15, wherein said searching step further comprises a step for sampling the patent materials searched corresponding to the specific classification codes in a constant ratio.

26. The method according to claim 25, wherein said constant ratio refers to a ratio of the number of the patent materials searched by the specified classification codes to the total number of the patent materials desired to be sampled.

27. The method according to claim 25, wherein said sampling step comprises a step for storing the sampled patent materials as a file.

28. The method according to claim 15, wherein said searching step further comprises a step for analyzing the searched patent materials into fields of a title or a field of the invention and/or a solution to problems and/or a method or a means for solution by the specific classification codes and/or by the specific key words.

29. The method according to claim 28, wherein said method for solution refers to a principle of an invention for solving problems of conventional arts.

30. The method according to claim 28, wherein said means for solution refers to an apparatus of an invention for solving problems of conventional arts.

31. The method according to claim 15, wherein said searching step further comprises a step for displaying the specific classification codes in a tree form at one part of a display means and displaying the patent materials searched by the specific classification codes and/or by the specific key words and the number of the correspondingly searched patent materials in a list form at another part of the display means at the same time.

32. The method according to claim 15, wherein said searching step further comprises a step for displaying predetermined numbers or symbols corresponding to each element of the searching conditions by a searching condition formula operated with logical operators such as “and” or “or” on a display means.

33. The method according to claim 15, wherein said searching step further comprises a step for displaying the specified classification codes in a tree form at one part of a display means, and displaying the fields having a title or field of the invention and/or a solution to the problem and/or a method or a means for solution for the searched patent materials at another part of the display means at the same time.

34. The method according to claim 33, wherein said searching step further comprises a step for displaying the fields in their displaying position.

35. The method according to claim 33, wherein said searching step further comprises a step for displaying the records of the searched patent materials consisting of the fields by changing the order of the records of the patent materials or by deleting them.

36. The method according to claim 33, wherein when one of said searched patent materials is selected, information on the selected patent material is displayed in detail.

37. The method according to claim 36, wherein said information on the patent material displayed in detail refers to a title or a field of the invention, an abstract and a representative figure.

38. The method according to claim 15, wherein said searching step further comprises a step for analyzing the searched patent materials into fields of a cause and a result by the specific classification codes and/or by the specific key words.

39. The method according to claim 38, wherein said searching step further comprises a step for displaying the specific classification codes in a tree form at one part of a display means, and displaying the fields of the cause and the result for the searched patent material by the classified classification code and/or by the specified key words at another part of the display means.

40. The method according to claim 15, wherein said searching step further comprises a step for analyzing the searched patent material into the fields of an effect and a use by the specific classification codes and/or by the specific key words.

41. The method according to claim 40, wherein said searching step further comprises a step for displaying the specified classification codes in a tree form at one part of a predetermined display means, and displaying the fields of the effect and the use for the searched patent material by the specific classification codes and/or by the specific key words at another part of the display means.

42. A method for analyzing patent material, comprising the steps of:
accessing previously searched patent materials and/or classified patent materials which were previously classified by a predetermined classifying condition;
inputting an analyzing condition of specific classification codes and/or specific key words to apply to the searched patent materials or to the classified patent materials; and
analyzing the searched patent materials or the classified patent materials on the basis of the inputted specific classification codes and/or the specified key words, and generating analyzed patent materials, wherein said specific classification codes refer to user defined structure classification codes structurally classifying the searched patent materials and/or classified patent materials, and/or user defined function classification codes functionally classifying the searched patent materials and/or the classified patent materials.

43. The method according to claim 42, wherein said accessing step comprises a step of loading a file of patent materials that were previously analyzed and stored.

44. The method according to claim 42, wherein said accessing step includes assessing the searched patent materials and/or the classified patent materials via an Internet web browser.

45. The method according to claim 42, wherein said specific classification codes refer to international patent classification codes.

46. The method according to claim 42, wherein said analyzing step further comprises the searching of the patent materials or the classified patent materials on the basis of at least one of inventor(s), applicant(s), application country, application date, application number, laid-open number, a term in the laid-open application, and patent number.

47. The method according to claim 42, wherein said analyzing step comprises a step of storing the analyzed patent materials as a file.

48. The method according to claim 42, wherein said analyzing step analyzes the searched patent materials and/or the classified patent materials into fields which comprise a title or a field of the invention and/or a solution to problems and/or a method or a means for solution by the specific classification codes.

49. The method according to claim 48, wherein said method for solution refers to a principle of an invention for solving problems of the conventional arts.

50. The method according to claim 48, wherein said means for solution refers to an apparatus of an invention for solving problems of the conventional arts.

51. The method according to claim 42, wherein the analyzing step further comprises a step for displaying the specified classification codes in a tree form at one part of a display means and displaying the number corresponding to the patent materials searched and/or analyzed by the specific classification codes and/or by the specific key words in a list form at another part of the display means.

52. The method according to claim 42, wherein the analyzing step further comprises a step for displaying the number of the searched patent materials or the analyzed patent materials corresponding to each specific classification code with a pie chart at one part of a display means and displaying such displayed patent materials in a list form at another part of the display means.

53. The method according to claim 42, wherein the analyzing step further comprises a step for displaying the number of the searched patent materials or the analyzed patent materials corresponding to each specific classification code with a bar map at one part of a predetermined display means and displaying such displayed patent materials in a list form at another part of the display means.

54. The method according to claim 42, wherein the analyzing step further comprises a step for displaying the number of the searched patent materials or the analyzed patent materials corresponding to each specific classification code with a transition map according to time period at one side of a display means and displaying such displayed patent materials in a list form at another part of the display means.

55. The method according to claim 42, wherein the analyzing step further comprises a step for displaying predetermined numbers or symbols that are previously defined corresponding to each element of the searching conditions by a searching condition formula or an analyzing condition formula operated with logical operators such as “and” or “or” on the display means.

56. The method according to claim 42, wherein said analyzing step further comprises a step for displaying the specified classification codes in a tree form at one part of a predetermined display means, and displaying the fields which comprise a title or a field of the invention and/or a solution to problems and/or a method or a means for solution for the searched patent materials or the analyzed patent materials at another part of the display means.

57. The method according to claim 56, wherein said analyzing step further comprises a step for displaying the fields in a specific displaying position order.

58. The method according to claim 56, wherein said analyzing step further comprises a step for displaying the records of the analyzed patent materials consisting of the fields by changing the order of the records or by deleting them.

59. The method according to claim 56, wherein when one of the analyzed patent materials is selected, information on the selected patent material is displayed in detail.

60. The methods according to claim 59, wherein said information on the patent material displayed in detail refers to a title of the invention, an abstract and a representative figure.

61. The method according to claim 42, wherein said analyzing step further comprises a step for analyzing the searched patent materials and the analyzed patent materials into fields which comprise a cause and a result by the specific classification codes and/or the specific key words.

62. The method according to claim 61, wherein said analyzing step further comprises a step for displaying the specific classification codes in a tree form at one part of a display means, and displaying the fields which comprise the cause and the result for the searched patent materials and/or the analyzed patent materials by the classified classification codes and/or the specific key words at another part of the display means.

63. The method according to claim 42, wherein said analyzing step further comprises a step for analyzing the searched patent materials and/or the analyzed patent materials into the fields which comprise an effect and a usage by the specific classification codes and/or specific key words.

64. The method according to claim 63, wherein the analyzing step further comprises a step for displaying the specific classification codes in a tree form at one part of a predetermined display means, and displaying the fields of the effect and the usage for the search patent materials and the analyzed patent materials by the classified classification codes and/or by the specified key words at another part of the display means.

65. A system for automatically processing patent materials, comprising:
a processing means for accessing raw patent materials, for classifying the patent materials based on text signaled by specific words in the raw patent materials to generate classified patent materials, and for searching and/or analyzing the classified patent materials according to specific user selected classification codes and/or user selected specified key words, to generate searched patent materials and/or analyzed patent materials; and
a user interface for receiving the user selected classification codes and/or user selected specified key words and for outputting a display of the processed patent materials on a display means.

66. The system according to claim 65, wherein said processing means accesses the raw patent materials via an Internet web browser.

67. The system according to claim 65, wherein said processing means comprises a storage means for storing the classified patent materials and/or the searched patent materials and/or the analyzed patent materials.

68. The system according to claim 65, wherein said classified patent materials comprise fields which include a title or a field of the invention and/or a solution to problems and/or a method or a means for solution.

69. The system according to claim 68, wherein said classified patent materials comprise fields of inventor(s), applicant(s), application country, application date, application number, laid-open number, laid-open date, laid-open term and a patent number.

70. The system according to claim 65, wherein said searched patent materials comprise fields which include user specified codes and the number of the patent materials corresponding to the user specified codes.

71. The system according to claim 65, wherein said analyzed patent materials comprise specific classification codes which are classified from the classified patent materials and the searched patent materials, and fields which include a title or a field of the invention and/or a solution to problems and/or a method or a means for solution corresponding to the specified classification codes.

72. The system according to claim 65, wherein said processing means comprises a means for generating edited patent materials which is shifted and deleted from the classified patent materials and/or the searched patent materials and/or the analyzed patent materials.

73. The system according to claim 72, wherein said processing means comprises a storage means for storing the edited patent materials.

74. The system according claim 65, wherein said user interface means displays the specified classification codes in a tree form at one part of a predetermined display means and displays the patent materials corresponding to the specified classification codes in a list form at another part of the predetermined display means, with respect to the classified patent materials and/or the searched patent materials and/or the analyzed patent materials.

75. The system according to claim 65, wherein said user interface means displays the specific classification codes and fields which include a title or a field of the invention and/or a solution to problems and/or a method or a means for solution corresponding to the specified classification codes at one part of the display means, with respect to the classified patent materials and/or the searched patent materials and/or the analyzed patent materials.

76. The system according to claim 65, wherein said user interface means comprises a means for displaying a title of the invention, an abstract and a representative figure in detail of the selected patent material, as one patent material is selected among the classified patent materials and/or the searched patent materials and/or the analyzed patent materials.

77. The system according to claim 65, wherein said user interface means further comprises a means for displaying the specific classification codes in a tree form at one part of the display means and displaying the number of the patent materials corresponding to the specified classification codes with a pie chart [map] at another [the other] part of the display means, with respect to the classified patent materials and/or the searched patent materials and/or the analyzed patent materials.

78. The system according to claim 65, wherein said user interface means further includes a means for displaying the specific classification codes with a bar map at one part of the display means and displaying the number of the patent materials corresponding to the specified classification codes in a list form at another part of the display, with respect to the classified patent materials and/or the searched patent materials and/or the analyzed patent materials, at the same time.

79. The system according to claim 65, wherein said user interface means further comprises a means for displaying a variation curve of each of the number of the patent materials classified or searched and/or analyzed according to an analyzing term by the specific classification codes at one part of the display means and displaying the number of the patent materials in a list form at another part of the display means, with respect to the classified patent materials and/or the searched patent materials and/or the analyzed patent materials, at the same time.

80. The system according to claim 65, further comprising:
a storage means for storing an application program for automatically processing patent materials and the patent materials processed by the application program.

81. The system according to claim 80, further comprising:
a network interface means so as to be connected to an external system through a network.

82. The system according to claim 81, wherein said external system connected to the network comprises servers and/or personal computers.

83. The system according to claim 80, wherein said storage means is connected to a magnetic recording medium or an optical recording medium recording/reproducing device so as to input patent materials stored in those recording media.
